(19) United States
(12) Patent Application Publication
(10) Pub. No.: US 2015/0139267 A1
(43) Pub. Date: May 21, 2015

(54) DEVICE AND METHOD TO CONTROL THE CHARGE IN ELECTRIC ARC FURNACES

(71) Applicant: DANIELI AUTOMATION SPA, BUTTRIO (IT)

(72) Inventors: Ferruccio Della Vedova, Pozzuolo Del Friuli (IT); Marco Ometto, Pasian Di Prato (IT)

(21) Appl. No.: 14/369,877

(22) PCT Filed: Dec. 28, 2012
(86) PCT No.: PCT/IB2012/002806

§ 371 Date: Jun. 30, 2014

(30) Foreign Application Priority Data
Dec. 29, 2011 (IT) UD2011A000216

(51) Int. Cl. F27D 21/00; F27D 3/00; F27B 3/28; F27B 3/08; F27B 3/18

(52) U.S. Cl. CPC F27D 21/0035; F27B 3/085; F27B 3/18; F27B 3/28; F27D 3/0025; F27D 2003/0034; F27D 2019/0075
USPC 373/79

(57) ABSTRACT

Device to control the feed of the metal charge in an electric arc furnace, comprising a conveyor associated at the end to a feed mouth provided in said electric arc furnace and, in cooperation with the conveyor, at least a system to detect the point-by-point profile of the metal charge present on the conveyor.

### FIELD OF THE INVENTION

The present invention concerns a device and the corresponding method to control the metal charge introduced into an electric arc furnace.

The metal charge according to the present invention mainly consists of undifferentiated scrap.

The invention advantageously concerns the introduction of the charge into the electric furnace through a specific opening made in the furnace, using transport means such as vibrating belts or conveyors.

### BACKGROUND OF THE INVENTION

It is known that the method for introducing the metal charge into an electric arc furnace, after tapping and in relation to any possible liquid heel remaining in the furnace, provides an advantageous progression that is widely adopted by those operating in this field.

For example, slabs of cast iron are introduced first, then low-value scrap mixed with other types of scrap, then higher value scrap, and finally another load of cast iron slabs.

The types of materials introduced depend on the type of steel to be obtained. It is also known that, in the case of continuous scrap conveyors, these cooperate with a specific hole in the roof or upper panel of the furnace

It is also known that the hole can then be closed or kept open, and that the fumes exiting from the furnace can be made to flow above and/or between the scrap, in a stand-by or transport step, in order to purify the fumes and at the same time to heat the scrap.

When the scrap is transported by conveyor belts or vibrating conveyors, these normally extend from the electric arc furnace at least as far as a warehouse, normally two, where piles of scrap are disposed, different in type and/or size.

Normally, two cranes per warehouse serve a continuous transporter to load the scrap in the desired sequence and quantities.

It is known that, in the case of continuous transporters, the charges deposited on the transporter must not exceed a certain bulk and must not leave interspaces free between one charge and the other.

The bulk is characteristic of the loading hole or mouth in the furnace.

The continuity of the charge is characteristic of the energy saving and loading time.

It is also known that the cranes pick up the scrap normally with magnets which can lift up to 5 tonnes and more of scrap at a time.

In relation to the solutions for loading electric arc furnaces known in the state of the art, one purpose of the present invention is to control the volume passing on the continuous conveyor.

It is also a purpose to control the bulk of the material passing on the continuous conveyor.

It is also a connected purpose to control the continuity of the charge in transit.

It is also a connected purpose to recreate continuity of the charge on the continuous conveyor.

It is also a connected purpose to control the presence of the slabs of cast iron at start and end.

It is a derived purpose to be able to integrate the charge with dedicated material.

Document U.S. Pat. No. 6,004,504 describes a continuous loading method for an electric arc furnace in which there is an optical system to detect the profile of the charge. U.S. '504 is intended to improve the control of the speed and quantity of charge fed to the furnace, in relation to optimizing the level and temperature of the liquid bath, but does not concern the control and optimization of the occupation of the surface of the conveyor.

WO-A-00506448 concerns a system, commanded by a camera, to crush compressible charge material so that it can pass through a dynamic seal. However, this document does not deal with the problem of optimizing the distribution of the metal charge on the conveyor either.

### SUMMARY OF THE INVENTION

The main purposes and advantages described above are obtained by a device and method according to the independent claims.

The dependent claims describe other purposes and advantages.

According to the invention, a system to detect the point-by-point profile of the metal charge is provided in association with a continuous conveyor.

According to a supplementary variant the system to detect the profile also detects the density of the metal charge in transit.

The point-by-point profile can be detected, in a first solution, with a brushing device or laser brush. In another solution, it is detected by an X-ray detection system.

The laser brush is able to draw the profile of the metal charge and therefore, in practice, indicates a specific volume occupied, and any possible insufficiencies present there. The X-ray detection identifies a specific area in transit and the density of the material in transit.

It is quite obvious that the X-ray detection not only allows to detect segments of the continuous conveyor where the metal charge is not present, or is present in limited quantities, but also allows to evaluate or control the weight of the charge thanks to the detection of the density of the area detected.

In association with the X-ray detection a system may be provided to control the maximum height that the charge of scrap can have inside the continuous conveyor.

As we said, the continuous conveyor can be a belt, or vibrating type. The continuous conveyor can also include pre-heating of the scrap or not, using the hot fumes exiting from the electric arc furnace.

If the detection system detects an insufficiency or discontinuity in the charge, it activates a command that drives a suitable container that selectively unloads an additional charge onto the conveyor, in the desired position.

In a preferential solution, two or more containers are advantageously distributed, distanced from each other, on the length of the conveyor.

The additional charge can have a fixed quantity or a quantity related to the insufficiency detected by the control system.

For example, the additional charge can be correlated either by using partial scrap containers, or containers associated with weighing means.

The containers can be replenished either by gantries or, according to a variant, with a specialized system of belts, or cranes, which unload the additional charge into the auxiliary containers.

For example, with the specialized system of belts it is possible to load into the containers scrap with a particular maximum shape and/or composition.

According to another variant, two detection systems are provided, one coarser, located upstream, and one finer, located downstream.

It is thus possible to provide, if necessary, a first coarse addition of metal charge downstream of the first detection system and, if necessary, a subsequent fine and point-by-point addition downstream of the second detection system.

According to a variant, the coarse and/or fine and point-by-point addition can also be made at a certain distance from the point of detection, since the advance of the material is controlled by the system and therefore the insufficiency remains known along the whole segment through which it passes.

With the system according to the invention it is also possible to control whether the charge of cast iron slabs is present in the head and tail zone of the charge, since the X-ray detection system also allows to identify this condition.

### DESCRIPTION OF THE DRAWINGS

These and other characteristics of the present invention will become apparent from the following description of one form of embodiment, given as a non-restrictive example with reference to the attached drawings wherein:

FIG. 1 shows schematically a possible form of embodiment of a device to control the charge in an electric arc furnace according to the invention;

FIG. 2 shows schematically the control and command system applied to the control device in FIG. 1;

FIG. 3 shows a schematization of an X-ray control system;

FIG. 4 shows a schematization of a control system with a laser brushing device;

FIG. 5 shows a schematization of a feed system of a container with specialized systems.

### DESCRIPTION OF SOME EXAMPLE EMBODIMENTS

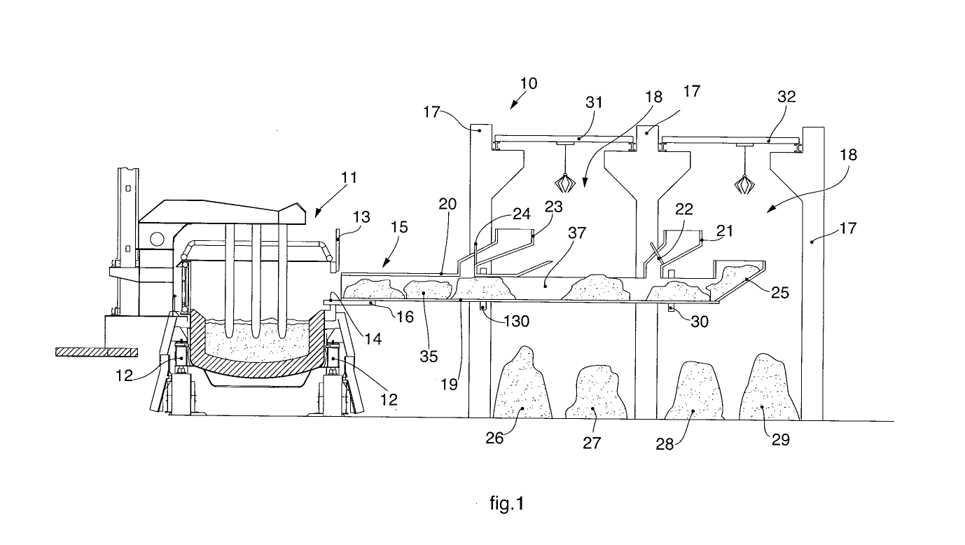

FIG. 1 shows schematically and synthetically an electric arc furnace 11 associated with a continuous conveyor 15 that is fed from cranes on gantries 31,32 operating in two adjacent warehouses where there are differentiated piles of scrap 26, 27, 28 and 29, or metal charge materials, such as slabs of cast iron or suchlike. In their entirety the components form a continuous conveyor system for the metal charge 10 of a generally known type. In this case, for example, the electric arc furnace 11 has an eccentric casting hole and is moved by one or more jacks 12. The electric arc furnace 11 has a mouth 14 to introduce a metal charge, or scrap, 35, which can be at least partly and selectively closed by closing means 13.

The charge 35 arrives at the mouth 14, in the desired composition, thanks to the continuous conveyor 15, and is sent to the furnace thanks to a retractable extension 16 so as not to interfere with the closing means 13.

In the case shown here, the continuous conveyor 15 has a cover 20 that allows to pre-heat the scrap with the fumes of the furnace.

The conveyor 15 has a conveyor channel 19, in this case the vibrating type with vibration devices 34 associated with it (FIGS. 3-5).

The conveyor 15, in the case shown here, serves two adjacent warehouses 18, where there are an appropriate number of cranes and corresponding gantries 31 and 32.

The cranes slide on tracks present on columns 17, in a known manner, and are used to pick up the scrap according to the desired sequence from the piles 26, 27, 28 and 29.

The scrap is unloaded either into a first hopper 25 which feeds it to the start of the conveyor 15, or directly onto the conveyor 15.

In the case shown in FIG. 1, there are two X-ray detection systems, respectively 30 and 130, associated with the conveyor 15.

In cooperation with the conveyor 15 there are also containers 21 and 23 served by respective interception means 22 and 24 which are activated to unload possible additional scrap into the conveyor 15.

The containers 21 and 23, or second hoppers, in the case of FIG. 1 are fed by respective components.

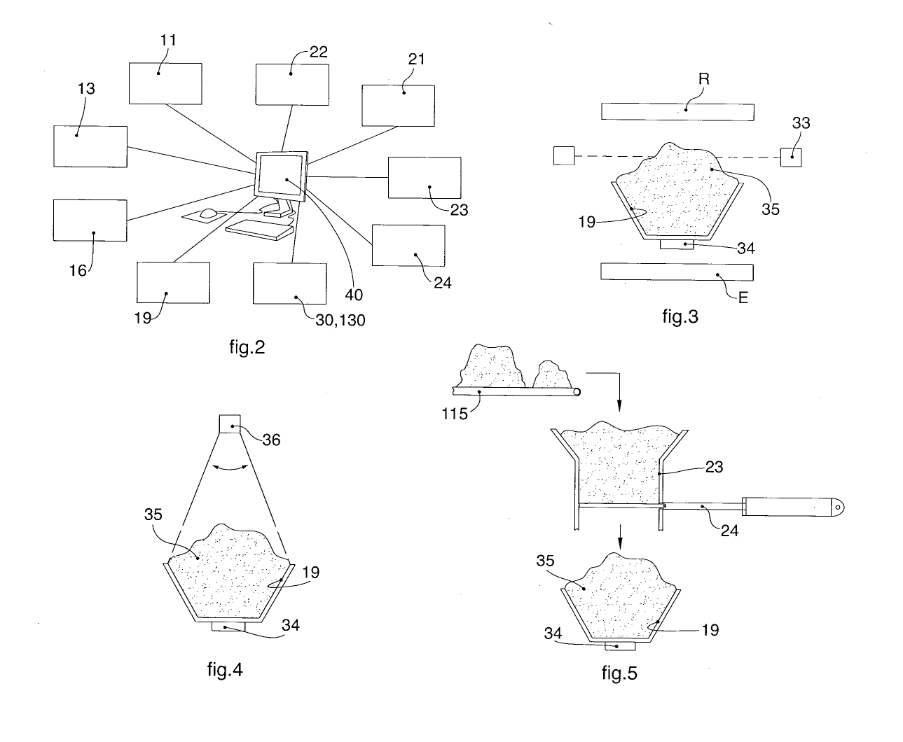

FIG. 2 shows a processing and control system 40 that assists, receives signals and commands the various activities connected to the conveyor 15.

FIG. 3 shows an X-ray detection system 30, 130 in which E is the emitter and R is the receiver.

A system to control the maximum bulk 33 is also provided.

In some preferential forms of embodiment it may be provided that the emitter E is disposed under the conveyor 15 and concentrated in proximity to the central zone of the latter. The emitter E is configured to emit X rays that substantially affect the whole section through which the conveyor channel 19 passes. The receiver R is disposed above the conveyor 15 and is for example provided with a plurality of sensitive elements suitable to receive the signals emitted by the emitter E.

It is quite obvious that, in other forms of embodiment, the position of the emitter E and receiver R can be inverted, that is, the emitter E is positioned above the conveyor channel 19 and the receiver R disposed below.

FIG. 4 shows a system to detect the profile of the scrap 35 using a laser brush 36 generated by a generator.

FIG. 5 shows a container 23 associated with a closing system 24, of a known type (the drawing indicates only that a closing system is present), fed by a specialized belt 115 that brings small pieces of scrap and for example particulate material.

According to the invention, when the X-ray detection system 30,130, or the detection system with laser brush 36, detects a zone 37 on the conveyor 15 that is empty or insufficiently filled, it drives one or another of the containers 21 or 23, also depending on the type of material required, in order to replenish the missing quantity.

It is clear that modifications and/or additions of parts may be made to the device 10 as described heretofore, without departing from the field and scope of the present invention.

1.-13. (canceled)

14. A device for feeding a metal charge into an electric arc furnace, comprising:
a conveyor to transport the metal charge into the electric arc furnace,
at least two loading devices disposed along the conveyor,
a detection system to detect a profile of the metal charge on the conveyor, and
a control system in a communication with the loading devices and the detection system,
wherein the control system is configured to selectively activate at least one of the loading devices to load additional metal charge onto the conveyor based on the profiles of the metal charge on the conveyor.

15. The device of claim 14, wherein the detection system further comprises at least an X-ray detection system.

16. The device of claim 15, wherein the detection system further comprises a height control system configured to control the maximum height of the metal charge on the conveyor.

17. The device of claim 14, wherein the detection system comprises at least a laser brushing system.

18. The device of claim 14, wherein the loading devices further comprise:
at least two cranes and at least two gantries, and
at least two loading hoppers having interception devices,
wherein the loading hoppers are disposed along the conveyor and configured to load a predetermined quantity of metal charge.

19. The device of claim 14, wherein the loading devices further comprise:
a hopper,
a belt to supply a metal charge to the hopper, and
a closing device configured to selectively release the metal charge in the hopper.

20. A method to feed a metal charge into an electric arc furnace, comprising
detecting profiles of the metal charge on a conveyor, and
selectively loading additional metal charge onto the conveyor based on the profiles of the metal charge on the conveyor.

21. The method of claim 20, wherein detecting profiles of the metal charge is conducted by a X-ray detection system.

22. The method of claim 21, wherein the X-ray detection system detects the density of the metal charge.

23. The method of claim 20, wherein detecting profiles of the metal charge is conducted by a laser brushing system.

24. The method of claim 20 wherein further comprising detecting the maximum height of the metal charge on the conveyor.

25. The method of claim 20, wherein the additional metal charge is based on a predeterminated sequence.

26. The method of claim 20 wherein further comprising
detecting profiles of the metal charge on a conveyor at a first position from the electric arc furnace,
selectively loading additional metal charge onto the conveyor based on the profiles of the metal charge on the conveyor,
detecting profiles of the metal charge on a conveyor at a second position from the electric arc furnace, and
selectively loading additional metal charge onto the conveyor based on the profiles of the metal charge on the conveyor.
